(19) United States
(12) Patent Application Publication
(10) Pub. No.: US 2004/0205013 A1
(43) Pub. Date: Oct. 14, 2004

(54) System and method for conducting an on-line auction

(76) Inventor: Cedric G. DeLaCruz, Maplewood, NJ (US)

Correspondence Address: Cedric G. DeLaCruz, 682 Prospect Street, Maplewood, NJ, 07040, US

(21) Appl. No.: 10/409,977

(22) Filed: Apr. 9, 2003

(51) Int. Cl. G06F 17/60

(52) U.S. Cl. 705/37

(57) ABSTRACT

A system and method for conducting an on-line auction where the winner of the auction is not necessarily the highest bidder since the bids may be adjusted based on the bidders prior auction history or feedback.

### BACKGROUND OF THE INVENTION

On-line auction services/sites provide a very valuable and very popular service since they allow sellers to easily and economically reach a large number of potential buyers/bidders and conversely allow buyers/bidders to access a large number of sellers in a similarly easy and economical manner. Though on-line auctions are typically conducted between unrelated third parties, many auction services/sites have established ways to rate or provide feedback for other auction participants in order to establish auction histories or background. For example, once an auction is completed, participants are be allowed to rate each other in the auction based on their satisfaction or dissatisfaction with the auction. A seller may rate a buyer and the same buyer may rate the seller. Once an auction participant establishes a number of positive feedbacks or reviews, that participant is considered to be more desirable to conduct business with. For example, buyers may be more inclined to bid for items being sold from a seller with a large number of positive feedbacks as opposed to a seller with no or little feedback. Similarly, a seller hopes to receive bids from buyers with higher positive feedback than buyers with little or low or negative feedback. In this manner, a community of self-policing auction participants is created.

However, current auction service providers/sites have not taken full advantage of this feedback system since auctions are still won based solely on the winning bid price, e.g. the highest bid still wins an auction. For example, it is possible for a bidder with zero or negative feedback to outbid a bidder with a large number of positive feedbacks by only a nominal amount of money in order to win an auction. Although a seller would more likely want to deal with the bidder with a large number of positive feedbacks than a bidder with low or little or negative feedback, the seller still is obligated to sell the item to the high bidder. This phenomenon is especially frustrating near the close of an auction where a seller may want to deal with a more established bidder who may then get outbid at the last moment by another “lesser qualified” bidder, i.e. a bidder with little or no or negative feedback ratings. The need or desire to deal with more established or reliable auction participants is even more heightened when dealing with certain auction items such as higher value items.

Accordingly, what is needed is an auction system and method which takes into account more than a final bid price in determining a winner for an auction. In such a desirable system and method, the winner is determined not only from the bid price but from other factors such as bidder feedback ratings and/or the value of the item being auctioned.

### SUMMARY OF THE INVENTION

The present invention is a system and method for conducting an auction which takes into account other factors such as user feedback ratings in determining a winner of the auction. In one embodiment, the present method comprises receiving information for an item to be listed for an auction, receiving bids from a plurality of bidders for the listed item, one or more of the plurality of bidders having established feedback ratings and determining a winner for the auction, wherein the winner is determined based at least in part on each bidder's feedback ratings. In the present invention, the bidder with the highest bid does not necessarily win the auction.

In another embodiment, the present invention is a method comprising receiving bids from a plurality of bidders for an auction, adjusting each bid based on each bidder's user profile entries and determining a winner for the auction based on the adjusted bids.

In yet another embodiment, the present invention is a method of conducting an on-line auction not based entirely on bidding price, the method comprising receiving a bid value from at least one bidder for the on-line auction, the bidder being identified by feedback provided from at least one previous auction participated in by the bidder, wherein a bidder not having participated in a previous auction has no feedback and adjusting the bid value received based at least in part on any available feedback provided from the previous auction for the bidder, wherein if there is more than one bidder the bid value for a bidder with good feedback is adjusted relatively higher while the bid value for a bidder with negative feedback is adjusted relatively lower, the bid value not being adjusted if there is only one bidder for the on-line auction.

### BRIEF DESCRIPTION OF THE DRAWINGS

FIG. 1 illustrates an exemplary method of the present invention.

FIG. 2 illustrates another exemplary method of the present invention.

FIG. 3 illustrates another exemplary method of the present invention.

FIG. 4 illustrates another exemplary method of the present invention.

### DETAILED DESCRIPTION OF THE INVENTION

The present invention relates to methods and systems for conducting auctions where additional factors such as the bidder's user history, feedback or reputation is utilized to determine a winning bidder of the auction. For purposes of this disclosure, the terms “reputation”, “user history”, “user profile”, “user feedback”, “feedback profile” and “feedback” are used interchangeably to refer to previously established comments or feedback an auction participant, such as a bidder or a seller, may have as a result of participating in previous auctions. For example, once an auction closes, the seller and bidder have the chance to provide feedback for each other regarding the transaction. Such feedback may be positive, negative, neutral, undecided, recommended, not recommended, etc. as well as additional comments about the transaction such as the speed of the transaction, the quality of the communications between the parties, etc. Typically, once an auction participant such as a bidder or seller has established or received a number of positive feedbacks, that bidder or seller will be more desirable to deal with to other bidders and sellers in future auction transactions. Conversely, once an auction participant such as a bidder or seller has established or received a number of negative feedback(s), that bidder or seller will be less desirable to other bidders and sellers in future auction transactions. It is contemplated that auction participants such as sellers and buyers with little or no feedback will also be less desirable to deal with as compared to those sellers and buyers with more established positive feedback profiles. Additionally, when comparing parties which have both positive feedback profiles, it is possible that the parties with a greater number of positive feedback will be more desirable to deal with than with those with less positive feedback and vice versa. Similarly, those with a lot of negative feedback will be less desirable to deal with than those with less negative feedback.

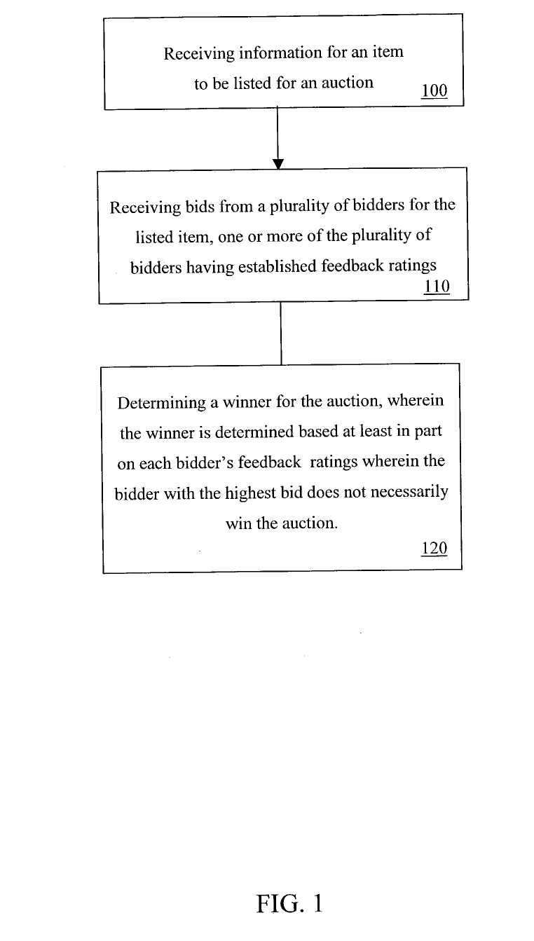

Referring to FIG. 1, one embodiment of a method of the present invention is shown. In this embodiment, the method comprises receiving information for an item to be listed for auction, step 100. Information received for the item typically relates to a description of the item such as color, condition, type, function, nature, desirability, form, shape and a variety of other descriptives related to the item which may be in the form of text, pictures, images, drawings, audio, links, etc. It is contemplated that the item being put up for the auction may be any good, commodity, service, combinations of goods, commodities and services which may be in any condition such as new, used, refurbished, etc. Referring still to FIG. 1, the method further comprises receiving bids from a plurality of bidders for the listed item, one or more of the plurality of bidders having established feedback ratings, step 110. In this embodiment of the present invention, one or more of the plurality of bidders has established feedback ratings. Once bids are received and typically a predetermined amount of time passes, a winner for the auction is determined, wherein the winner is determined based at least in part on each bidder's feedback ratings wherein the bidder with the highest bid does not necessarily win the auction, step 120. In the above exemplary embodiment, it is conceivable that there may be only bidder for the auction item and in this case, the feedback ratings may be ignored and the bidder's bid taken at its face value without any adjustment based on the bidder's feedback rating.

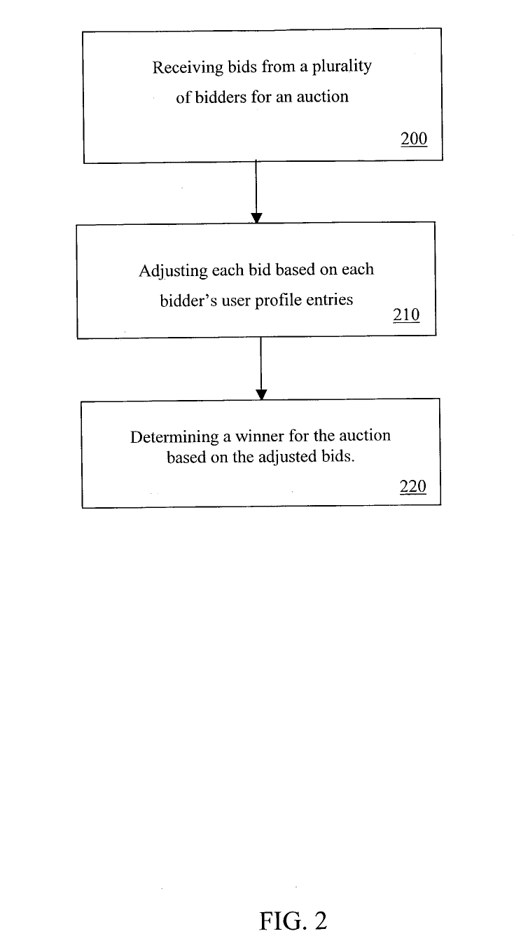

Referring to FIG. 2, in another embodiment, the present invention is a method comprising receiving bids from a plurality of bidders for an auction, step 200, adjusting each bid based on each bidder's user profile entries, step 210 and determining a winner for the auction based on the adjusted bids, step 220. As discussed in more detail later herein, adjustments to each bid amount may be made upwards or greater for those with positive feedback profiles and conversely, adjustments to each bid may be made downwards or lower for those with negative feedback profiles. For example, a bid of say, $100 from a bidder with a positive feedback profile may be adjusted to say, $105 based on that positive feedback whereas a bidder with a negative feedback profile with the same $100 bid may have the bid adjusted to $95 based on that negative feedback profile. Essentially, the present invention is valuing bids from bidders with better reputation more highly and discounting bids from bidders with bad reputations. In one embodiment, even though a bidder's bid is adjusted, the bidder will still only be responsible for paying their actual bid should that bidder be deemed or be determined to be the winner of the auction. For example, even if a bid amount from a bidder with a positive profile is adjusted upwards, that bidder will not have to pay the upwards adjusted bid. In another embodiment, it is conceivable that the bidder would be responsible for paying the adjusted bid amount. For example, in the case of where a bid amount from a bidder with a negative profile is adjusted downward and that bidder still wins the auction based on the downward adjusted bid amount, then that bidder will only be responsible for paying the downwards adjusted bid amount.

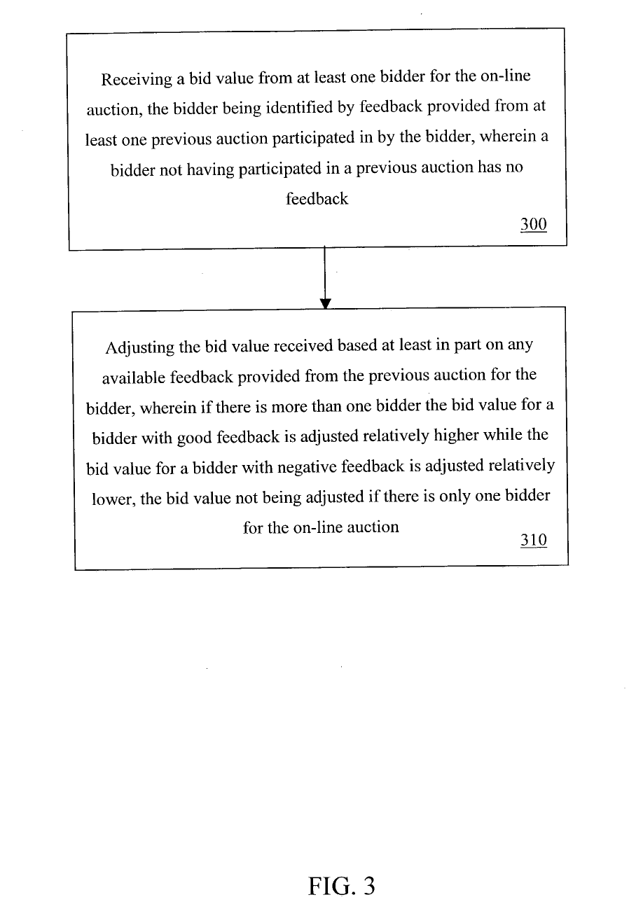

Referring to FIG. 3, in yet another embodiment, the present invention is a method of conducting an on-line auction not based entirely on bidding price, the method comprising receiving a bid value from at least one bidder for the on-line auction, the bidder being identified by feedback provided from at least one previous auction participated in by the bidder, wherein a bidder not having participated in a previous auction has no feedback, step 300. The method further comprises adjusting the bid value received based at least in part on any available feedback provided from the previous auction for the bidder, wherein if there is more than one bidder the bid value for a bidder with good feedback is adjusted relatively higher while the bid value for a bidder with negative feedback is adjusted relatively lower, the bid value not being adjusted if there is only one bidder for the on-line auction, step 310.

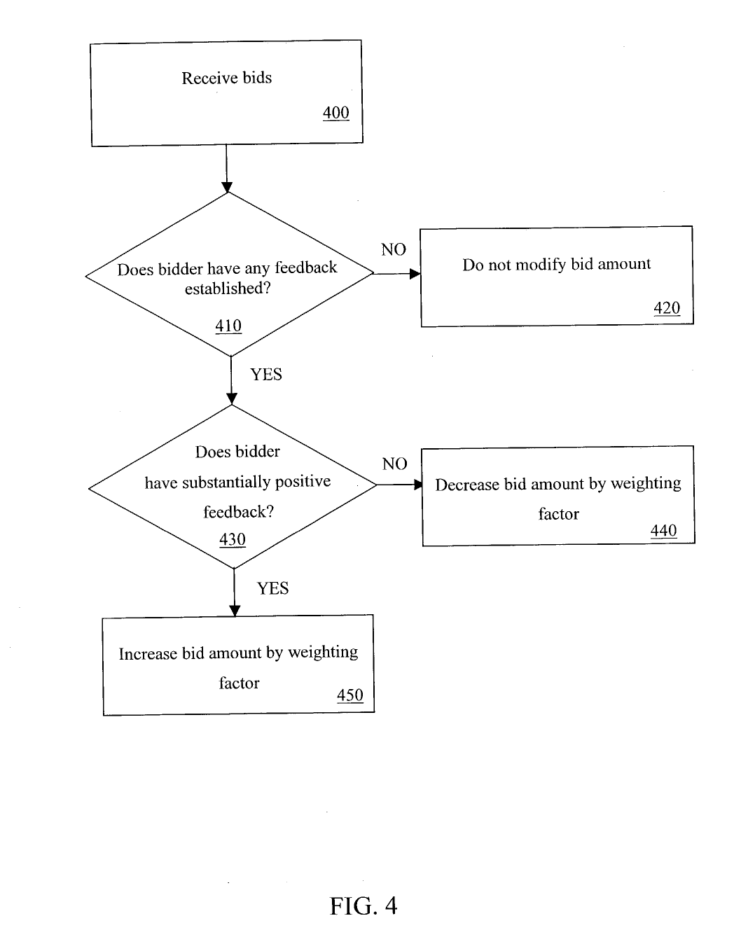

Referring to FIG. 4, another embodiment of the present invention is shown. In this embodiment, bids are received, step 400. It is determined if the bidder has any feedback established, step 410. If the bidder has no feedback established, the bidder's bid amount is not adjusted in any way, step 420. If the bidder has feedback established, it is determined if the bidder has substantially positive feedback, step 430, e.g. the bidder has more positive feedback than negative feedback. If the bidder does not have substantially positive feedback, then the bidder's bid amount is decreased by a weighting factor, step 440. If the bidder does have substantially positive feedback, that bidder's bid amount is increased by the weighting factor, step 450. In one embodiment of the present invention, the weighting factor may be a percentage which the bid amount may be increased or decreased and may be determined in a number of manners. For example, the more positive feedback a bidder has, the more the bidder's bid amount may be increased, e.g. for every X positive feedbacks the bidder has, the bid amount is increased by Y percentage, where X and Y are any real numbers. Conversely, the more negative feedback a bidder has, the more the bidder's bid amount may be decreased, e.g. for every Z negative feedbacks the bidder has, the bid amount is decreased by W percentage, where Z and W are any real numbers.

In one more specific exemplary scenario, a bidder AAA with a positive history/feedback rating of +100 who bid a certain amount $200 for an item would still win the auction over a bidder BBB with a negative history/feedback rating of −1 who bid $205 for the same item. In this exemplary scenario, bidder AAA's actual bidding amount of $200 would be increased by an adjustment of Y percentage, such as 5% based on the bidder AAA's +100 rating bringing bidder AAA's adjusted bidding amount to $210 while bidder BBB with a rating of −1 would have the actual bid amount of $205 remain the same at $205 or even adjusted to a lower amount, such as to $200, e.g. reduced by 2.5%. Other variations of the above exemplary scenario are possible.

In one additional specific exemplary scenario, a bidder DDD with a positive history/feedback rating of +10 who bid a certain amount $100 for an item would still win the auction over a bidder EEE with no feedback ratings who bid $101 for the same item. In this exemplary scenario, bidder DDD's actual bidding amount of $100 would be increased by an adjustment of Y percentage, such as 2% based on the bidder DDD's +10 rating bringing bidder DDD's adjusted bidding amount to $102 while bidder EEE with no feedback rating would still have a bid amount of $101.

In another additional specific exemplary scenario, a bidder FFF with all positive feedback who bid a certain amount $100 for an item would still win the auction over a bidder GGG with some positive feedback and some negative feedback who bid $101 for the same item. In this exemplary scenario, bidder FFF's actual bidding amount of $100 would be increased by an adjustment of Y percentage, such as 2.5% based on the bidder FFF's all positive feedback bringing bidder FFF's adjusted bidding amount to $102.50 while bidder GGG with some positive feedback and some negative feedback would still have a bid amount of $101.

In the present invention, it is contemplated that when adjusting the bids based on the factors described herein that competing adjusted bids may equal each other, i.e. two or more bids may end up in a tie. Priority for these bids would then be decided on a predetermined basis, for example, in the case of a tie, the bidder with more positive feedback would be given priority or be adjudged to have the priority bid. Conversely, if competing bids end up in a tie from two bidders have negative feedback, then the bidder with relatively less negative feedback would be adjusted to have the priority bid.

In another embodiment of the present invention, another factor that may be considered in weighting or adjusting the bidder's bid amounts is the value of the item being auctioned. For example, a threshold may be set that if the bidding amount for an item goes over a certain level, then certain factors may have more or less weight in adjusting the bids. For example, in one exemplary embodiment, if bidding for an item exceeds an amount, say $1000, then a bidder having positive feedback is given even more weight in adjusting the bid amount. For example, in one exemplary scenario, if the bidding for an item is below $1000, a bid for a bidder having positive feedback is adjusted upwards 1%, but if bidding goes above $1000, then the same bidder's bid will be adjusted upwards 2%. Conversely, if the bidding for an item is below $1000, a bid for a bidder having negative feedback is adjusted downwards 1%, but if bidding goes above $1000, then the same bidder's bid will be adjusted downward 2%.

The present invention may be implemented within a network-based auction facility such as an Internet-based auction facility which may include a number of types of interoperative servers such as front-end server(s), page server(s), picture server(s), listing server(s), processing server(s), search server(s), E-mail server(s), back-end server(s), database engine server(s), search index server(s) and credit card database server(s) or combinations and variations thereof which are effective to render and deliver an on-line auction environment to one or more clients or users such as any number of bidders or sellers in accordance with the teachings of the present invention.

This Internet-based auction facility may be accessed by a client program such as a browser that runs on a client machine or device and accesses the auction facility via one or more networks such as the Internet. Other examples of networks that a client may utilize to access the auction facility include a wide area network (WAN), a local area network (LAN), a wireless network (e.g., a cellular network), or the Plain Old Telephone Service (POTS) network or combinations thereof.

In the present invention, such aforementioned networks generally provides interconnection utilizing various interconnection architectures including Internet Protocol (IP) based networks such as the Internet, the public switched telephone network (PSTN), ATM networks, signaling networks, wireless networks, satellite networks, fixed wireless networks, DSL networks as well as other systems. Such networks provide versatile intelligent conduits that may carry, for example, communications between the clients and the auction facility.

Furthermore, while the present invention has been described with reference to a number of exemplary embodiments, it will be understood by those of ordinary skill in the art that various changes may be made and equivalents may be substituted for elements and steps thereof without departing from the scope of the invention. In addition, many modifications may be made to adapt a particular device, situation, component or step to the teachings of the invention without departing from the scope thereof. Therefore, it is intended that the invention not be limited to the particular embodiment disclosed, but that the invention will include all embodiments falling within the scope of the appended claims.

What is claimed is:

1. A method comprising:
receiving information for an item to be listed for an auction;
receiving bids from a plurality of bidders for the listed item, one or more of the plurality of bidders having established feedback ratings; and
determining a winner for the auction, wherein the winner is determined based at least in part on each bidder's feedback.

2. The method of claim 1, wherein a bidder is more likely to be determined to be a winner of the auction if the bidder has positive feedback ratings.

3. The method of claim 1, wherein a bidder is less likely to be determined to be a winner of the auction if the bidder has negative feedback ratings.

4. The method of claim 1, wherein a bid from a bidder with positive feedback ratings has their bid adjusted upwards, the bidder being responsible for only paying their original bid if the bidder is determined to be the winner of the auction.

5. The method of claim 1, wherein a bid from a bidder with negative feedback ratings has their bid adjusted downwards, the bidder being responsible for paying the downward adjusted bid if the bidder is determined to be the winner of the auction.

6. The method of claim 1, wherein a bidder with one or more feedback ratings is more likely to win an auction than a bidder with no feedback ratings.

7. The method of claim 1, wherein the winner is determined based additionally in part on a value of the auction item such that the higher the value of the auction item, the more the bidder's feedback ratings is weighted in determining the winner.

8. The method of claim 1, wherein the winner is determined based additionally in part on a value of the auction item such that the lower the value of the auction item, the less the bidder's feedback ratings is weighted in determining the winner.

9. The method of claim 8, wherein the winner is determined based on assigning a weighted factor to each bidder's feedback ratings and adjusting each bidder's bid based on the weighted factor such that a bid from a bidder with a relatively higher feedback ratings is adjusted higher than a bid from a bidder with a lower feedback rating.

10. A method comprising:
receiving bids from a plurality of bidders for an auction;
adjusting each bid based on each bidder's user profile entries; and
determining a winner for the auction based on the adjusted bids.

11. The method of claim 10, wherein a bid from a bidder with a less desirable user profiles is adjusted downward.

12. The method of claim 10, wherein a bid from a bidder with a more desirable user profiles is adjusted upward.

13. The method of claim 10, wherein the winner is determined at least additionally in part on a value of the auction.

14. The method of claim 10, wherein adjusting the bids comprises weighting a user profile having positive entries more favorably than a user profile with negative entries.

15. The method of claim 10, wherein adjusting the bids comprises weighting a user profile with more entries more favorably than a user profile having less entries.

16. The method of claim 10, further comprising providing a display of bidders with each bidder's actual bid and adjusted bid.

17. A method of conducting an on-line auction comprising:
receiving a bid value from at least one bidder for the on-line auction, the bidder being identified by feedback provided from at least one previous auction participated in by the bidder, wherein a bidder not having participated in a previous auction has no feedback; and
adjusting the bid value received based at least in part on any available feedback provided from the previous auction for the bidder, wherein if there is more than one bidder the bid value for a bidder with good feedback is adjusted relatively higher while the bid value for a bidder with negative feedback is adjusted relatively lower, the bid value not being adjusted if there is only one bidder for the on-line auction.

18. The method of claim 17, wherein the more valuable the auction item, the more the bids are adjusted based on the feedback.

19. The method of claim 17, further comprising:
declaring a winning bidder of the auction based on the adjusted bid value.

20. The method of claim 17, wherein the feedback weighted more important in adjusting bid values the higher the relative value of the on-line auction.
